(19) United States
(12) Patent Application Publication
(10) Pub. No.: US 2013/0078492 A1
(43) Pub. Date: Mar. 28, 2013

(54) BATTERY

(71) Applicants: Takeshi Sasaki, Kyoto (JP); Sumio Mori, Kyoto (JP); Minoru Teshima, Kyoto (JP); Taro Yamafuku, Kyoto (JP)

(72) Inventors: Takeshi Sasaki, Kyoto (JP); Sumio Mori, Kyoto (JP); Minoru Teshima, Kyoto (JP); Taro Yamafuku, Kyoto (JP)

(73) Assignee: GS YUASA INTERNATIONAL LTD., Kyoto-shi, Kyoto (JP)

(21) Appl. No.: 13/701,996

(22) PCT Filed: Jun. 6, 2011
(86) PCT No.: PCT/JP2011/062881

§ 371 Date: Dec. 4, 2012

(30) Foreign Application Priority Data
Jun. 14, 2010 (JP) 2010-135610

(51) Int. Cl. H01M 2/30; H01M 4/00

(52) U.S. Cl. CPC H01M 2/30; H01M 4/00
USPC 429/94; 429/179

(57) ABSTRACT

The present invention suppresses movement of a power generating element in a case of a battery while minimizing an increase in a workload in an assembly process of the battery.

In the battery including: a power generating element 3; a case BC housing the power generating element 3; an electrode terminal 5 disposed outside the case; a current collector 4 connected to the power generating element 3; and a fixing member FE for fixing the current collector 4 to the case BC and having electric conductivity, the current collector 4 and the fixing member FE forming an energizing path between the power generating element 3 and the electrode terminal 5, a spacer 11 which is positioned by engagement with the fixing member FE and which suppresses movement of the power generating element 3 is disposed between the fixing member FE and the power generating element 3.

### TECHNICAL FIELD

The present invention relates to a battery including a power generating element, a case housing the power generating element, an electrode terminal disposed outside the case, a current collector connected to the power generating element, and a fixing member for fixing the current collector to the case and having electric conductivity. The current collector and the fixing member form an energizing path between the power generating element and the electrode terminal.

### BACKGROUND ART

A basic structure of the battery includes a power generating element housed in a case of the battery and current collectors for electrically connecting the power generating element and the electrode terminals mounted to the case.

As a general structure, the current collectors and the power generating element are connected by welding or the like and the current collectors are fixed to the case by fixing members such as rivets and are electrically connected to the electrode terminals through the fixing members.

The power generating element is a structure supported by the current collectors and is a group of foil-shaped members in general. The foil-shaped members are supported while welded to the current collectors.

Therefore, if strong vibration or a shock is applied to the case of the battery, a force for relatively displacing the power generating element acts due to an inertial force and the force acts on joints between the power generating element and the current collectors.

The force acting on the joints between the power generating element and the current collectors may separate them from each other or damage the power generating element itself.

Furthermore, if the power generating element is displaced to come in contact with current paths from the electrode terminals to the current collectors, a resin separator included in the power generating element contracts due to heat generation when high current is applied, which causes an internal short circuit failure.

Therefore, as described in the following Patent Document 1, for example, disposition of members for suppressing movement of the power generating element near the power generating element in the case of the battery has been conceived conventionally.

### PRIOR ART DOCUMENTS

### Patent Documents

Patent Document 1: JP-A-2000-030676

### SUMMARY OF THE INVENTION

### Problems to be Solved by the Invention

However, by only disposing the members for suppressing the movement of the power generating element as in the above-described prior-art structure, the disposition of the members requires additional work in an assembly process of structural parts of the battery.

The present invention has been made with such circumstances in view and its object is to suppress the movement of the power generating element in the case of the battery while minimizing an increase in a workload in the assembly process of the battery.

### Means for Solving the Problems

A first invention according to the present application is a battery comprising: a power generating element; a case housing the power generating element; an electrode terminal disposed outside the case; a current collector connected to the power generating element; and a fixing member for fixing the current collector to the case and having electric conductivity, the current collector and the fixing member forming an energizing path between the power generating element and the electrode terminal, wherein a spacer which is positioned by engagement with the fixing member and which suppresses movement of the power generating element is disposed between the fixing member and the power generating element.

In other words, problems in efficiency in assembly operation are how to carry out positioning of a spacer and how to retain the spacer in a mounted position in mounting the spacer for suppressing the movement of the power generating element in an assembly process of the battery.

In the mounting operation of the spacer, a member for positioning and retaining the spacer may be mounted to the case of the battery or the case or the current collector may be formed in such a shape as to be able to position and retain the spacer.

However, if the special part is prepared for mounting of the spacer or the structural part is formed into the special shape for mounting of the spacer as described above, it causes an increase in cost for the part.

In this point, an outer shape of the fixing member for fixing the current collector to the case is in a shape protruding or recessed in a direction of moving close to and away from the power generating element in many cases and the positioning of the spacer is carried out by engaging the spacer with this shape.

Therefore, in the assembly process of the battery, the mounting operation of the spacer for suppressing the movement of the power generating element can be extremely simplified.

Moreover, the spacer engaged with the fixing member can be utilized for positioning of the power generating element by bringing the power generating element into contact with the spacer in a joining operation of the power generating element and the current collector to thereby contribute to improvement of workability in the assembly of the battery in this point as well.

When strong vibration or a shock is applied to the case of the battery, not only a force for relatively displacing the power generating element but also a force on the current collector acts. Especially, a force is likely to act on a point where the current collector is fixed to the case, i.e., a connection portion between the fixing member and the current collector and the connection portion may be damaged.

In this point, by disposing the spacer engaged with the fixing member between the fixing member and the power generating element, it is possible to protect the connection portion between the fixing member and the current collector.

In other words, even if the force acts on the connection portion between the fixing member and the current collector due to the shock or the vibration, the connection portion is fixed by the spacer and therefore is less likely to be damaged. Moreover, because the connection portion is covered with the spacer, it is also possible to suppress damage to the connection portion due to contact with the power generating element.

In a second invention according to the application, in addition to the structure of the above-described first invention, the fixing member is formed by a hollow rivet for fixing the current collector to the case with at least an inner side of the hollow rivet with respect to the case caulked and the spacer is positioned while fitted into a hollow portion in the hollow rivet.

In other words, as a result of a close study of the assembly process of the battery and the structural parts, it was found that the hollow rivet can be utilized for the positioning of the spacer by forming the spacer into a suitable shape when the hollow rivet is used for mounting of the electrode terminal and the current collector and electric wiring.

If the hollow rivet is used, the hollow portion in the hollow rivet is normally positioned on the inner side of the case of the battery. Therefore, if a portion of the spacer is formed in such a shape as to be fitted into the hollow portion, it is possible to carry out the positioning of the spacer by only inserting the portion into the hollow portion.

Therefore, in the assembly process of the battery, the mounting operation of the spacer for suppressing the movement of the power generating element can be extremely simplified.

In a third invention according to the application, in addition to the structures in the above-described first and second inventions, the spacer is formed by integrally forming a portion positioned between the fixing member and the power generating element on a positive electrode side and a portion positioned between the rivet member and the power generating element on a negative electrode side.

Therefore, it is possible to suppress the movement of the power generating element both on the positive and negative electrode sides with the single part.

In a fourth invention according to the application, in addition to the structure in any one of the above-described first to third inventions, the power generating element is formed as a winding-type power generating element formed by winding long foil-shaped positive electrode plate, negative electrode plate, and separator in a layered state and a face of the spacer facing the power generating element is formed in a shape of a recessed face adapted to a shape of a side face of the power generating element curved by the winding.

In other words, because what is called the winding-type power generating element is formed by winding the foil-shaped positive electrode plate and the like many times, the side face of the power generating element is in the curved shape and the power generating element is disposed in such an attitude that the curved side face faces the spacer.

In this case, by forming the face of the spacer facing the power generating element into the shape of the recessed face adapted to the outer shape (the shape of the curved side face) of the power generating element, the spacer stabilizes and appropriately holds the attitude of the power generating element which tries to move to thereby suppress the movement.

In a fifth invention according to the application, in addition to the structure in any one of the above-described first to fourth inventions, the current collector is formed into a bent shape having a portion extending along a face of the case to which the electrode terminal is mounted and a portion extending in a direction of a normal to the face of the case to which the electrode terminal is mounted and the spacer is formed in a shape extending to a bent portion of the current collector.

In other words, the current collector is in the shape having the portion extending along the face to which the electrode terminal is mounted so as to be connected to the electrode terminal by the rivet member and the portion extending in the direction of the normal to the face to which the electrode terminal is mounted so as to be joined to the power generating element.

If the current collector is in such a bent shape, the current collector is supporting a load of the power generating element and therefore the shape of the current collector bends when the vibration or the like is applied to the battery.

Such bending of the shape of the current collector applies stress to the joint between the power generating element and the current collector.

Therefore, the spacer disposed close to the current collector is formed in such a shape as to extend to the bent portion of the current collector and the current collector is supported at its bent portion by the spacer.

In this way, even if the vibration is applied to the battery, the bending of the current collector can be suppressed.

In a sixth invention according to the application, in addition to the structure in any one of the above-described first to fifth inventions, a portion not applied with an active material is formed on one end side of at least one of the positive electrode plate and the negative electrode plate included in the power generating element and the spacer is disposed between the fixing member and the not-applied portion.

A portion applied with the active material of the positive electrode plate or the negative electrode plate applied with the active material expands or contracts when the battery is used. If the positive electrode plate or the negative electrode plate has the not-applied portion, the portion applied with the active material expands or contracts while the not-applied portion does not, which hardly causes a change in volume.

In other words, by disposing the spacer between the fixing member and the not-applied portion, it is possible to suppress generation of a gap between the spacer and the power generating element and generation of unnecessary pressure in the power generating element when the battery is used. As a result, it is possible to prevent the movement of the power generating element in the case of the battery irrespective of a use situation of the battery. Although it is preferable to dispose the spacer only between the fixing member and the not-applied portion in order to further effectively obtain the above-described operation, the operation can be obtained if at least a portion of the spacer is disposed between the fixing member and the not-applied portion.

### Advantages of the Invention

According to the first invention, the fixing member used for mounting of the current collector and the electric wiring can be used as it is for the positioning of the spacer for suppressing the movement of the power generating element and the spacer can be used for the positioning of the power generating element in joining the current collector and the power generating element. Therefore, it is possible to suppress the movement of the power generating element in the case of the battery while minimizing the increase in the workload in the assembly process of the battery.

According to the second invention, the hollow portion in the hollow rivet remaining after the hollow rivet is caulked to fix the current collector to the case is used to carry out the positioning of the spacer and therefore it is possible to appropriately carry out the positioning of the space without requiring special working of the parts.

According to the third invention, it is possible to suppress the movement of the power generating element both on the positive and negative electrode sides with the single part and therefore it is possible to reduce the number of parts and cost.

According to the fourth invention, the spacer is formed into the shape of the recessed face to stabilize and appropriately hold the attitude of the power generating element which tries to move to thereby suppress the movement. Therefore, it is possible to more reliably prevent detachment of the power generating element from the current collector.

According to the fifth invention, it is possible to suppress the bending of the current collector when the vibration or the like is applied to the battery. Therefore, it is possible to more reliably protect the joined state of the current collector and the power generating element to each other.

According to the sixth invention, it is possible to suppress the movement of the power generating element in the case of the battery irrespective of the use situation of the battery.

### BRIEF DESCRIPTION OF THE DRAWINGS

FIG. 1 is an external perspective view of a battery according to an embodiment of the present invention.

FIG. 2 is a perspective view of an inner structure of the battery according to the embodiment of the invention.

FIG. 3 is an enlarged sectional view of an essential portion according to the embodiment of the invention.

FIG. 4 is a front view of the battery according to the embodiment of the invention.

FIG. 5 is a perspective view of a spacer according to the embodiment of the invention.

FIG. 6 is a perspective view of the spacer according to the embodiment of the invention.

FIG. 7 is a perspective view of a spacer according to another embodiment of the invention.

FIG. 8 is a front view of a battery according to another embodiment of the invention.

### MODES FOR CARRYING OUT THE INVENTION

Embodiments of a battery according to the present invention will be described below based on the drawings.

In each of the embodiments, a nonaqueous electrolyte secondary battery (more specifically, a lithium ion battery) which is an example of a secondary battery will be described as the battery.

### [Structure of Nonaqueous Electrolyte Secondary Battery RB]

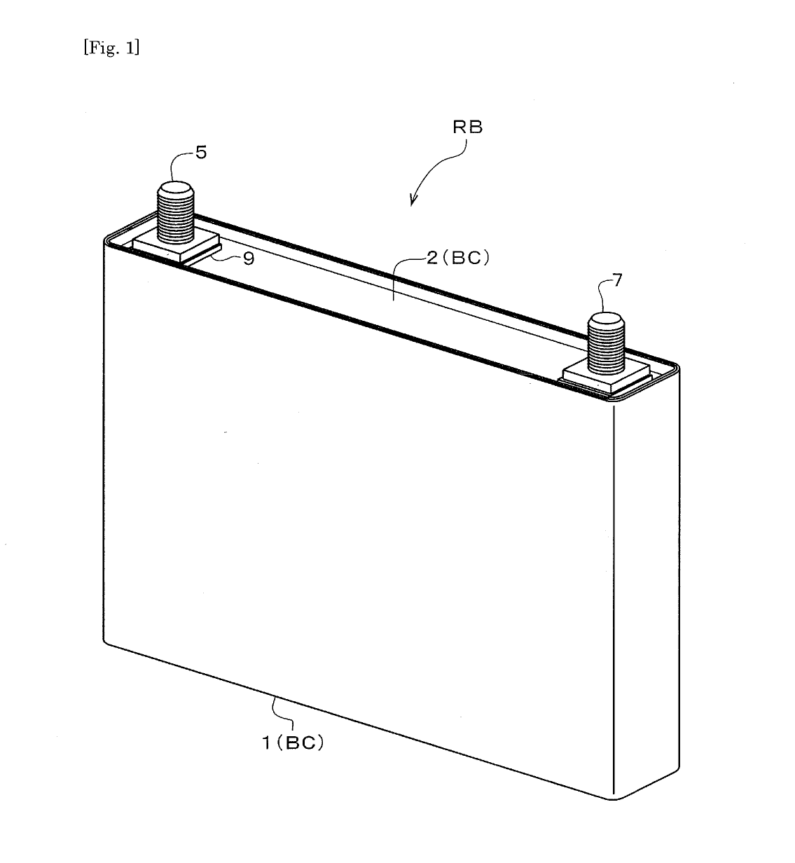

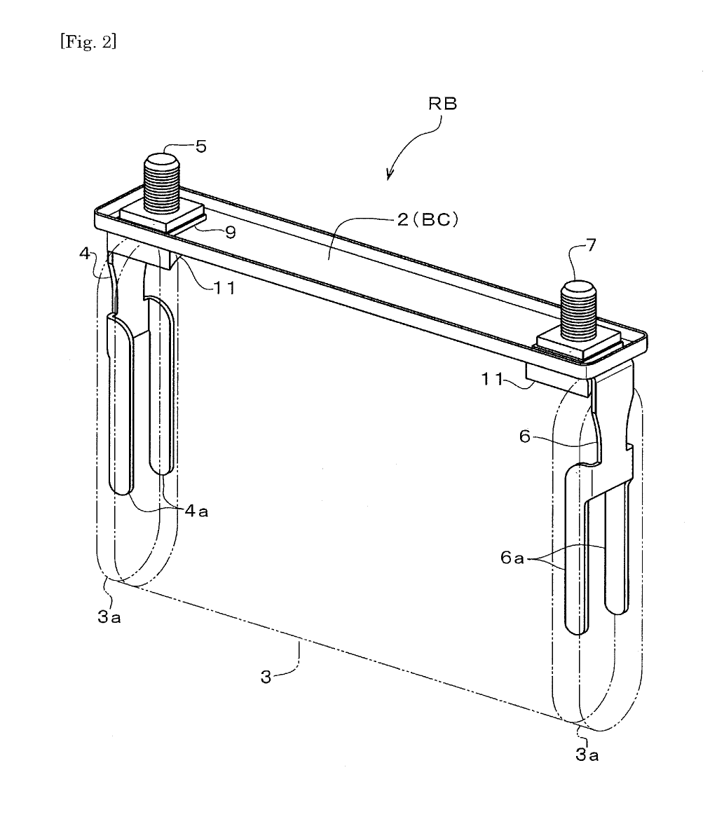

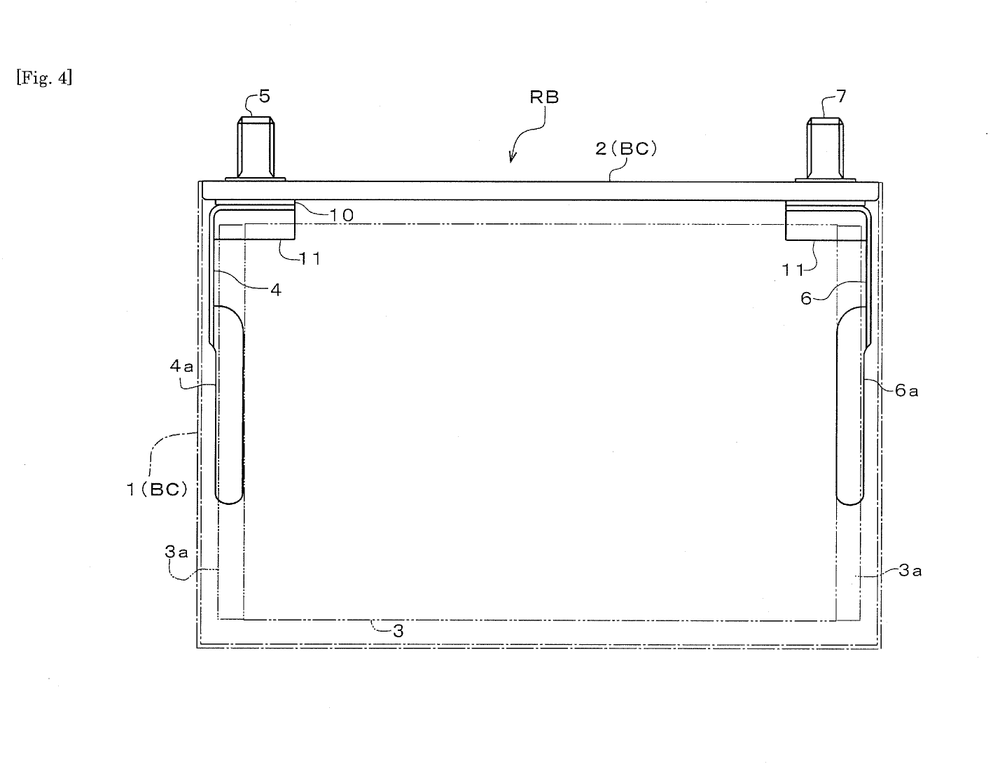

As shown in perspective views in FIGS. 1 and 2 and a front view in FIG. 4, the nonaqueous electrolyte secondary battery RB in the embodiment has a case BC formed by placing and welding a lid portion 2 onto an open face of a can body 1 in a cylindrical shape with a bottom (more concretely, a rectangular cylindrical shape with a bottom). The lid portion 2 is formed into a shallow plate shape by bending, at a right angle, an end edge portion of a strip-shaped rectangular plate member throughout an entire periphery and a terminal bolt 5 which is a positive electrode terminal and a terminal bolt 7 which is a negative electrode terminal are mounted to a face of the lid portion 2 on an outer side of the case BC.

The can body 1 is a flat rectangular parallelepiped adapted to a shape of the lid portion 2 and therefore the entire case BC is in a shape of a flat rectangular parallelepiped. FIG. 2 shows an inner structure of the case BC by removing the can body 1 from the completed secondary battery RB (shown in FIG. 1). In FIG. 4, the can body 1 is shown by one-dot chain lines and a power generating element 3 (described later) is shown by two-dot chain lines to facilitate visualization of the inner structure.

In the case BC, the power generating element 3 shown by the two-dot chain lines in FIGS. 2 and 4 and current collectors 4 and 6 are housed while immersed in an electrolyte solution.

The current collectors 4 and 6 are members for electrically connecting the power generating element 3 and the terminal bolts 5 and 7.

Both of the current collector 4 and the current collector 6 are conductive bodies having the same shapes and arranged symmetrically but are made of different materials. The current collector 4 on a positive electrode side is made of aluminum and the current collector 6 on a negative electrode side is made of copper.

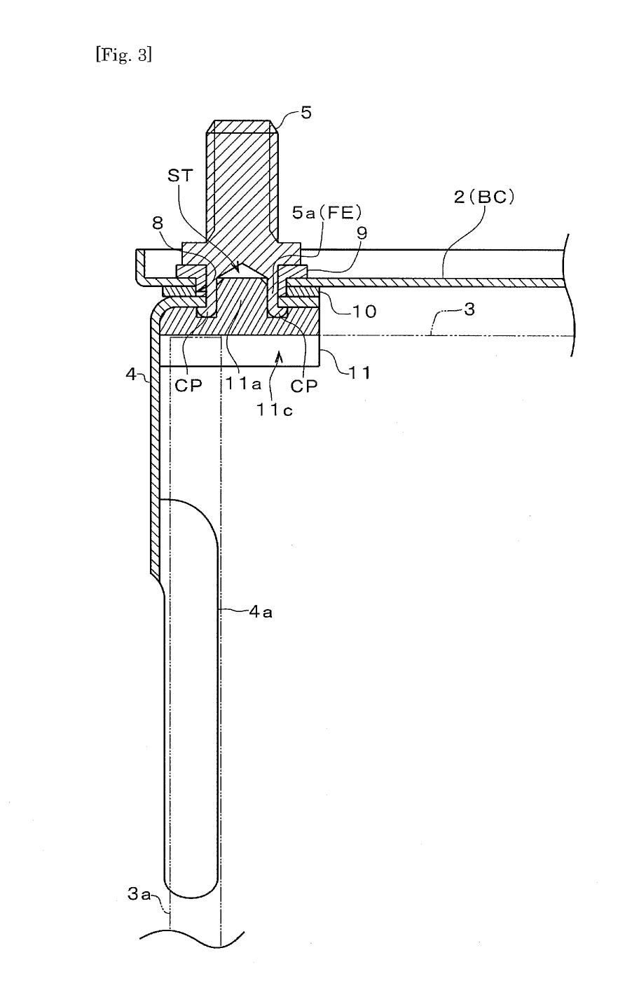

Each of the current collectors 4 and 6 has a bent shape similar to an L shape including a portion extending along the lid portion 2, which is a face mounted with the terminal bolt 5 or 7, to be connected to the terminal bolt 5 or 7 and a portion bending down at 90° near an end portion in a longitudinal direction of the lid portion 2 and extending in a direction of a normal to the lid portion 2 to be connected to the power generating element 3, the portions formed next to each other (see FIG. 3). At the portion extending in the direction of the normal to the lid portion 2, connection portions 4a or 6a to be connected to the power generating element 3 are formed.

The power generating element 3 is formed as what is called a winding-type power generating element formed by applying an active material on two electrode plates including a positive electrode plate formed in a long foil shape and a negative electrode plate formed in a long foil shape and winding the electrode plates in a layered state with a similarly long separator sandwiched therebetween.

In the above-described wound state of the power generating element 3, a portion 3a of the foil-shaped positive electrode plate not applied with the active material extends out from a side (in a direction orthogonal to a longitudinal direction of the foil-shaped positive electrode plate) and a portion 3a of the foil-shaped negative electrode plate not applied with the active material extends out from an opposite side (in a direction orthogonal to a longitudinal direction of the foil-shaped negative electrode plate).

The power generating element 3 in the embodiment is formed by winding the foil-shaped positive electrode plate and the like and flattening it in a direction orthogonal to a winding axis into a flat shape to adapt to the flat case BC.

The power generating element 3 is disposed in such an attitude in the can body 1 that the winding axis of the foil-shaped positive electrode plate and the like is parallel to the longitudinal direction of the lid portion 2. In a front view as shown in FIG. 4, the not-applied portion 3a of the foil-shaped positive electrode plate is positioned to overlap the connection portions 4a of the current collector 4 and the not-applied portion 3a of the foil-shaped negative electrode plate is positioned to overlap the connection portions 6a of the current collector 6.

The not-applied portion 3a of the foil-shaped positive electrode plate is welded to the current collector 4 in a bundled state and the not-applied portion 3a of the foil-shaped negative electrode plate is welded to the current collector 6 in a bundled state.

The terminal bolt 5 on the positive electrode side mounted to the lid portion 2 made of metal (specifically, aluminum) is electrically connected to the current collector 4 on the positive electrode side and the terminal bolt 7 on the negative electrode side is electrically connected to the current collector 6 on the negative electrode side.

A structure for mounting the terminal bolt 5 to the lid portion 2 and a structure for connecting the terminal bolt 5 and the current collector 4 are the same as a structure for mounting the terminal bolt 7 to the lid portion 2 and a structure for connecting the terminal bolt 7 and the current collector 6 and the same structures are arranged symmetrically. The structures on the positive electrode side will be described below as representatives.

As shown in a sectional view in FIG. 3, a rivet member 5a which is a fixing member FE for fixing the current collector 4 to the case BC and having electric conductivity is integrally molded with a head portion side of the terminal bolt 5. The terminal bolt 5 is disposed with the rivet member 5a passing through an electrode mounting hole 8 formed in the lid portion 2.

The terminal bolt 5 and the current collector 4 are mounted and fixed to the lid portion 2 by pinching two pieces of packing 9 and 10, disposed to sandwich the lid portion 2, between the head portion of the terminal bolt 5 and the current collector 4 and caulking an end portion of the rivet member 5a on an inner side of the case BC. By this mounting and fixing, the rivet member 5a and the current collector 4 form an energizing path between the power generating element 3 and the terminal bolt 5 to electrically connect the power generating element 3 and the terminal bolt 5.

The rivet member 5a is what is called a hollow rivet and a hollow portion ST exists between a caulked position CP and an inner side of the rivet member 5a after the rivet member 5a is caulked.

Between the rivet member 5a and the power generating element 3, a spacer 11 is disposed.

The spacer 11 is for suppressing movement of the power generating element 3 toward the rivet member 5a when vibration or a shock is applied to the secondary battery RB and the spacer 11 and the power generating element 3 are substantially in close contact with each other in the state in which the power generating element 3 is fixed to the current collector 4.

The spacer 11 is disposed astride the rivet member 5a and the power generating element 3 and astride the rivet member 5a and the not-applied portion 3a of the foil-shaped positive electrode plate or the foil-shaped negative electrode plate.

As material of the spacer 11, resin such as PPS (polyphenylene sulfide), PP (polypropylene), PE (polyethylene), and PVDF (polyvinylidene fluoride) used for packing, a separator, and the like may be used and PPS is particularly preferable from a viewpoint of heat resistance.

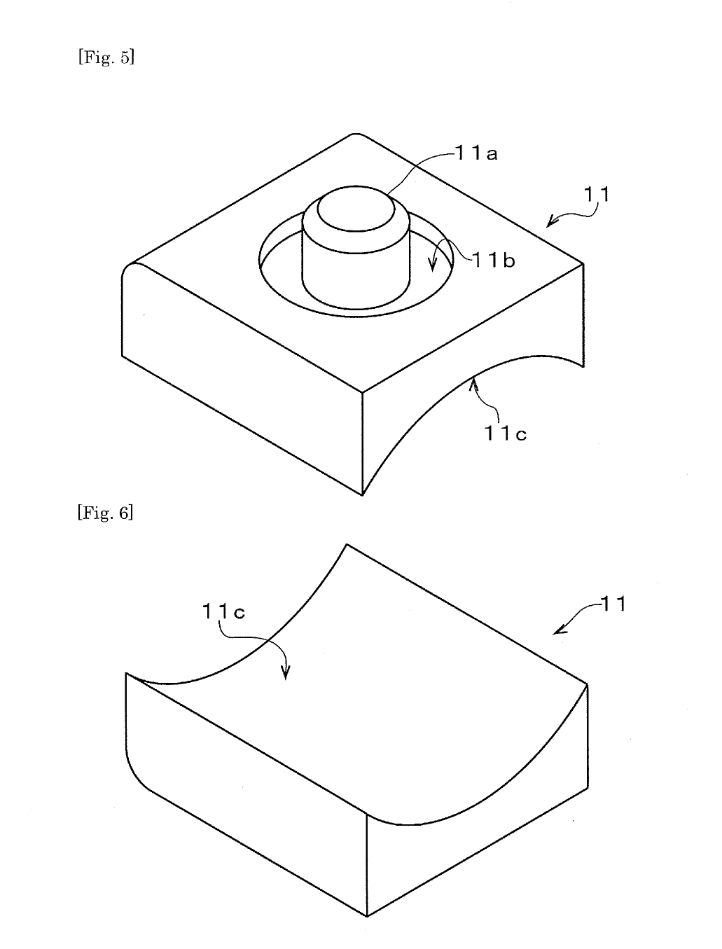

The spacer 11 is formed in a shape as shown in FIGS. 5 and 6.

FIG. 5 is a perspective view of the spacer 11 from the side of the rivet member 5a and FIG. 6 is a perspective view of the spacer 11 from the side of the power generating element 3.

As shown in FIG. 5, a circular columnar protruding portion 11a is formed on a face of the spacer 11 on the side of the rivet member 5a and a ring-shaped recessed groove 11b is formed around a base end of the circular columnar protruding portion 11a.

As shown in FIG. 6, a recessed face 11c substantially in a shape of an inner face of a cylinder is formed on a face of the spacer 11 on the side of the power generating element 3.

As shown in FIG. 3, the circular columnar protruding portion 11a is to be fitted into the hollow portion ST in the rivet member 5a to carry out positioning of the spacer 11 in a mounted position and maintain a mounted attitude of the spacer 11 and dimensions of an outer shape of the circular columnar protruding portion 11a and an inner diameter of the hollow portion ST are set so as to achieve loose interference fit.

The recessed groove 11b is for bringing the current collector 4 and the spacer 11 into close contact with each other by inserting a caulked portion (the portion shown as the caulked position CP) of the rivet member 5a into the recessed groove 11b when the circular columnar protruding portion 11a is fitted into the hollow portion ST in the rivet member 5a (see FIG. 3).

The spacer 11 extends to the bent portion of the current collector 4 near the end portion in the longitudinal direction of the lid portion 2 and is in close contact with a vertical wall face of the current collector 4 (a face of the portion extending in the direction of the normal to the lid portion 2 which is the mounting face of the terminal bolt 5).

Therefore, a corner portion of the spacer 11 in contact with the bent portion of the current collector 4 is rounded to adapt to a shape of the bent portion of the current collector 4.

The recessed face 11c of the spacer 11 facing the power generating element 3 is formed into the shape of the recessed face to adapt to a shape of a side face of the power generating element 3 which is curved by winding the foil-shaped positive electrode plate and the like and flattening them.

As schematically shown in FIG. 2, opposite side end portions of a flat face of the flattened power generating element 3 are formed as curved faces having small radiuses of curvature and the power generating element 3 is disposed in the case BC with the opposite side end portions disposed at upper and lower positions. Therefore, the shape of the recessed face 11c is in the shape best adapted to the curved face of the upper end (the upper end in the housed attitude in the case BC) of the power generating element 3 having the small radius of curvature.

Although it is not shown in the drawings, the negative electrode side including the spacer 11 and the like has the same structure as the positive electrode side except that the structures on the negative electrode side and the positive electrode side are disposed in symmetric attitudes and that metal members are made of different materials.

The metal members on the positive electrode side are made of aluminum in principle and the metal members on the negative electrode side are made of copper in principle.

### [Manufacturing Process of Secondary Battery RB]

Next, a manufacturing process of the secondary battery RB will be described briefly.

First, the case BC of the secondary battery RB is assembled.

As described above, the power generating element 3 is formed by respectively applying a positive electrode active material and a negative electrode active material on the long band-shaped foil-shaped positive electrode plate and foil-shaped negative electrode plate, winding the plates with the separator sandwiched therebetween after drying treatment or the like, and pressing the plates into a flat shape. The foil-shaped positive electrode plate and the foil-shaped negative electrode plate have the not-applied portions 3a which are positioned at one end sides in a width direction and are not applied with the active materials to be connected to the current collectors 4 and 6. The foil-shaped positive electrode plate and the foil-shaped negative electrode plate are wound so that the positive electrode and negative electrode not-applied portions 3a are positioned at opposite end edge portions from each other and that the not-applied portions 3a protrude sideways.

On the other hand, the electrode mounting holes 8 for mounting the terminal bolts 5 and 7 are formed in advance in the lid portion 2 and the current collectors 4 and 6 and the terminal bolts 5 and 7 are fixed to the lid portion 2, with the pieces of packing 9 and 10 interposed therebetween, by caulking the rivet members 5a.

After caulking the rivet members 5a, the spacers 11 are brought in orientations in mounted states shown in FIG. 3 and the circular columnar protruding portions 11a of the spacers 11 are fitted into the hollow portions ST in the rivet members 5a.

Next, by welding the not-applied portions 3a of the power generating element 3 to the current collectors 4 and 6 fixed to the lid portion 2 as described above, the lid portion 2 and the power generating element 3 are integrated with each other.

Welding operation of the power generating element 3 is carried out after positioning the power generating element 3 by bringing the curved face of the side end portion of the power generating element 3 into contact with the recessed faces 11c of the spacers 11.

In this way, it is possible to improve workability in the assembly of the power generating element 3.

Then, by housing the power generating element 3 in the can body 1 and welding the lid portion 2 and the can body 1 to each other, the assembly of the case BC of the secondary battery RB is completed.

After the assembly of the case BC is completed, the electrolyte solution is injected into the case BC through an electrolyte solution filling opening (not shown) and initial charge (preliminary charge), aging, and the like are carried out.

### Other Embodiments

Other embodiments of the invention will be listed below.

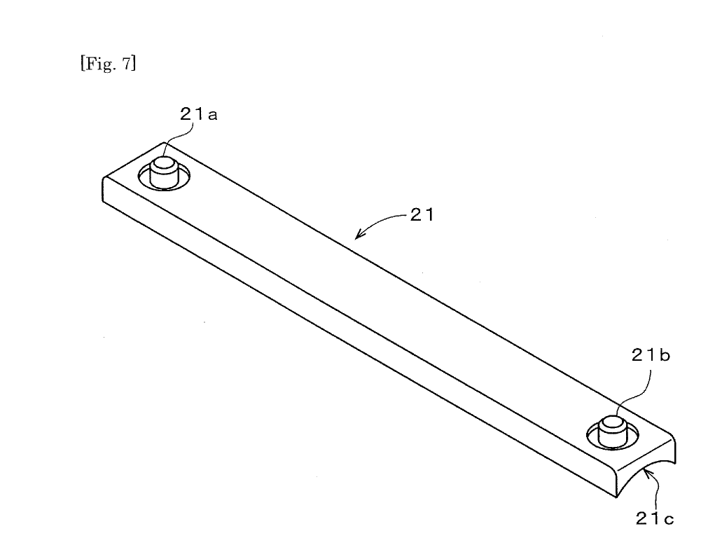

(1) Although the separate spacers 11 are provided separately on the positive electrode side and the negative electrode side in the example described in the above-described embodiment, a portion positioned between a rivet member and a power generating element 3 on a positive electrode side and a portion positioned between a rivet member and the power generating element 3 on a negative electrode side may be formed integrally as shown in FIG. 7.

A spacer 21 shown in FIG. 7 is formed by forming a circular columnar protruding portion 21a to be fitted into a positive electrode-side rivet member 5a and a circular columnar protruding portion 21b to be fitted into a negative electrode-side rivet portion on a single member and further forming a recessed face 21c adapted to a curved face of the power generating element 3 on a face opposite from a face on which the circular columnar protruding portions 21a and 21b are formed.

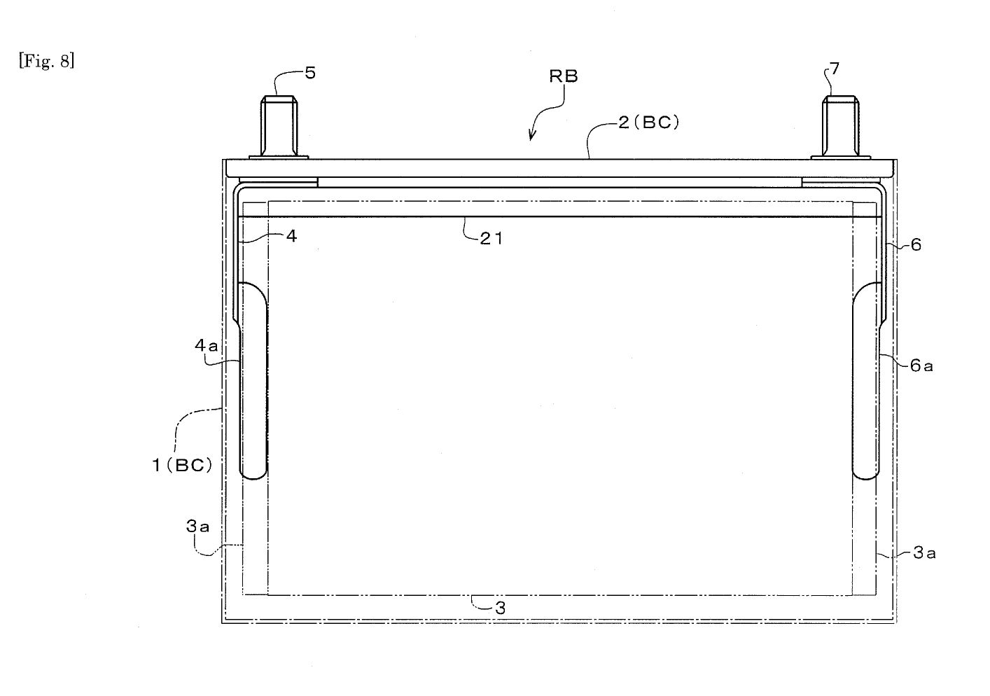

As shown in FIG. 8 showing a mounted state of the spacer 21 in FIG. 7, the spacer 21 exists throughout an entire width from a bent portion of a positive electrode-side current collector 4 to a bent portion of a negative electrode-side current collector 6 to suppress movement of the power generating element 3 and to suppress bending of the current collectors 4 and 6.

(2) Although the rivet members 5a are provided to the head portions of the terminal bolts 5 and 7 which are the electrode terminals and the electrode terminals and the rivet members are molded integrally in the example described in the above-described embodiment, rivet members may be provided as independent hollow rivets and may be connected to separate terminal bolts by bus bars or the like.

Alternatively, solid rivets may be used in place of the hollow rivets. If the solid rivets are used, after a caulking process, protruding portions protruding from caulked positions CP (see FIG. 3) toward a power generating element 3 are formed. By forming recessed portions to be fitted over the protruding portions in spacers 11, it is possible to carry out positioning of the spacers.

Moreover, bolts may be used in place of the hollow rivets. If the bolts are used, current collectors and a lid portion are fixed to each other by carrying out a process for disposing nuts on thread portions of the bolts and fastening the bolts instead of the caulking process. After this process, head portions of the bolts are protruding from a back face of the lid portion toward a power generating element. By forming recessed portions to be fitted over the head portions of the bolts in spacers 11, it is possible to carry out positioning of the spacers 11. If the bolts are used, recessed portions (hollow portions) may be formed in the head portions of the bolts. In this case, by forming protruding portions to be fitted into the hollow portions on the spacers 11, it is possible to carry out the positioning.

### DESCRIPTION OF REFERENCE SINGS

BC case
FE fixing member
ST hollow portion
3 power generating element
4, 6 current collector
5, 7 electrode terminal
5a rivet member (hollow rivet)
11, 21 spacer

1. A battery comprising: a power generating element; a case housing the power generating element; an electrode terminal disposed outside the case; a current collector connected to the power generating element; and a fixing member for fixing the current collector to the case and having electric conductivity, the current collector and the fixing member forming an energizing path between the power generating element and the electrode terminal,
wherein a spacer which is positioned by engagement with the fixing member and which suppresses movement of the power generating element is disposed between the fixing member and the power generating element.

2. The battery according to claim 1, wherein the fixing member is formed by a hollow rivet for fixing the current collector to the case with at least an inner side of the hollow rivet with respect to the case caulked and
the spacer is positioned while fitted into a hollow portion in the hollow rivet.

3. The battery according to claim 1, wherein the spacer is formed by integrally forming a portion positioned between the fixing member and the power generating element on a positive electrode side and a portion positioned between the rivet member and the power generating element on a negative electrode side.

4. The battery according to claim 1, wherein the power generating element is formed as a winding-type power generating element formed by winding long foil-shaped positive electrode plate, negative electrode plate, and separator in a layered state and
a face of the spacer facing the power generating element is formed in a shape of a recessed face adapted to a shape of a side face of the power generating element curved by the winding.

5. The battery according to claim 1, wherein the current collector is formed into a bent shape having a portion extending along a face of the case to which the electrode terminal is mounted and a portion extending in a direction of a normal to the face of the case to which the electrode terminal is mounted and
the spacer is formed in a shape extending to a bent portion of the current collector.

6. The battery according to claim 1, wherein a portion not applied with an active material is formed on one end side of at least one of the positive electrode plate and the negative electrode plate included in the power generating element and the spacer is disposed between the fixing member and the not-applied portion.
